(19) United States
(12) Patent Application Publication
(10) Pub. No.: US 2026/0310116 A1
(43) Pub. Date: Oct. 8, 2026

(54) SLEEVE, DEVELOPER CARRYING MEMBER, AND DEVELOPING DEVICE

(71) Applicant: CANON KABUSHIKI KAISHA, Tokyo (JP)

(72) Inventors: RYOHEI TERADA, Chiba (JP); ATSUSHI MATSUMOTO, Ibaraki (JP); MASAHARU MIURA, Ibaraki (JP)

(21) Appl. No.: 19/576,247

(22) Filed: Mar. 24, 2026

(30) Foreign Application Priority Data
Apr. 4, 2025 (JP) 2025-062174
Mar. 6, 2026 (JP) 2026-036133

(51) Int. Cl. G03G 15/08

(52) U.S. Cl. CPC G03G 15/0818; G03G 15/0891; G03G 2215/0607; G03G 2215/0861

(57) ABSTRACT

A rotatable sleeve including a developer carrying and conveying portion configured to carry and convey a developer containing toner and a carrier to a developing position, the developer carrying and conveying portion including a groove portion which is a portion where a groove is formed and a non-groove portion where the groove is not formed. In a case where a depth of the groove is D, a radius of the carrier is R, and a width of the groove in a rotational direction of the sleeve is W, D>R and W>2R are satisfied. The non-groove portion includes a chromium layer on an outer surface of the sleeve, and the chromium layer is 1 μm or more and 5 μm or less in thickness.

### BACKGROUND

### Field of the Technology

The present disclosure relates to a sleeve, a developer carrying member, and developing device.

### Description of the Related Art

As a developing system such that an electrostatic latent image formed on an image bearing member is developed with toner, a system using a two-component developer containing the toner and a carrier has been known. In the case of the two-component development system, the toner is carried on the developer carrying member such as a developing sleeve after being sufficiently stirred with the carrier immediately after the toner is supplied. For this reason, usually, the developer carrying member carries the carrier carrying the toner thereon, not the toner alone.

However, when a layer thickness of the developer carried on the developer carrying member is regulated by a regulating member or when the developer is carried conveyed on a surface of the developer carrying member, the toner is liberated from the carrier and is deposited alone onto the developer carrying member in some cases. When the toner is deposited alone on the developer carrying member, there is a liability that a surface potential of the developer carrying member is locally changed depending on a charge amount of the deposited toner in an opposing portion where the developer carrying member opposes the image bearing member and that with the change, an amount of the toner with which the electrostatic latent image is developed on the image bearing member and a density of an image after fixing is fluctuated (hereinafter, simply referred to as density unevenness (non-uniformity).

As a countermeasure against such deposition of the toner onto the developer carrying member, in Japanese Laid-Open Patent Application (JP-A) Nos. Hei 9-251237, 2005-157002, and Hei 11-231652, constitutions each in which the toner deposited on the developer carrying member is collected by a scraper, a toner collecting roller, or the like is proposed. Further, JP-A No. 2013-064856, a constitution in which accumulation of the toner onto the developer carrying member is suppressed by coating a surface of the developer carrying member with titanium nitride is proposed.

However, in the case of the constitution in which the toner deposited on the developer carrying member is collected by the scraper, the toner collecting roller, or the like as in JP-A Nos. Hei 9-251237, 2005-157002, and Hei 11-231652, a constitution of a device (apparatus) is complicated, and in addition, a cost of the device is increased. Further, in the case of the constitution in which the surface of the developer carrying member is coated with the titanium nitride, a cost of the device is increased.

### SUMMARY

The present disclosure is directed to suppress deposition of toner onto a developer carrying and conveying portion for carrying and conveying a developer containing toner and a carrier to a developing position.

According to an aspect of the present disclosure is to provide a rotatable sleeve comprising: a developer carrying and conveying portion configured to carry and convey a developer containing toner and a carrier to a developing position, the developer carrying and conveying portion including a groove portion which is a portion where a groove is formed and a non-groove portion where the groove is not formed, wherein in a case where a depth of the groove is D, a radius of the carrier is R, and a width of the groove in a rotational direction of the sleeve is W, D>R and W>2R are satisfied, and wherein the non-groove portion includes a chromium layer on an outer surface of the sleeve, and the chromium layer is 1 μm or more and 5 μm or less in thickness.

According to another aspect of the present disclosure is to provide a rotatable sleeve comprising: a developer carrying and conveying portion configured to carry and convey a developer containing toner and a carrier to a developing position, the developer carrying and conveying portion including a groove portion which is a portion where a groove is formed and a non-groove portion where the groove is not formed, wherein in a case where a depth of the groove is D, a radius of the carrier is R, and a width of the groove in a rotational direction of the sleeve is W, D>R and W>2R are satisfied, and wherein each of the groove portion and the non-groove portion includes a chromium layer on an outer surface of the sleeve.

According to another aspect of the present disclosure is to provide a developer carrying member comprising: a rotatable sleeve; and a magnet provided inside the sleeve, wherein the sleeve includes a developer carrying and conveying portion which is configured to carry and convey a developer containing toner and a carrier to a developing position and which includes a groove portion which is a portion where a groove is formed and a non-groove portion where the groove is not formed, wherein in a case where a depth of the groove is D, a radius of the carrier is R, and a width of the groove in a rotational direction of the sleeve is W, D>R and W>2R are satisfied, and wherein the non-groove portion includes a chromium layer on an outer surface of the sleeve, and the chromium layer is 1 μm or more and 5 μm or less in thickness.

According to another aspect of the present disclosure is to provide a developer carrying member comprising: a rotatable sleeve; and a magnet provided inside the sleeve, wherein the sleeve includes a developer carrying and conveying portion which is configured to carry and convey a developer containing toner and a carrier to a developing position and which includes a groove portion which is a portion where a groove is formed and a non-groove portion where the groove is not formed, wherein in a case where a depth of the groove is D, a radius of the carrier is R, and a width of the groove in a rotational direction of the sleeve is W, D>R and W>2R are satisfied, and wherein each of the groove portion and the non-groove portion includes a chromium layer on an outer surface of the sleeve.

According to another aspect of the present disclosure is to provide a developing device comprising: a developing container configured to accommodate a developer containing toner and a carrier; and a developer carrying member including a rotatable sleeve and a magnet provided inside the sleeve, a magnet provided inside the sleeve, wherein the sleeve includes a developer carrying and conveying portion which is configured to carry and convey the developer to a developing position and which includes a groove portion which is a portion where a groove is formed and a non-groove portion where the groove is not formed, wherein in a case where a depth of the groove is D, a radius of the carrier is R, and a width of the groove in a rotational direction of the sleeve is W, D>R and W>2R are satisfied, and wherein the non-groove portion includes a chromium layer on an outer surface of the sleeve, and the chromium layer is 1 μm or more and 5 μm or less in thickness.

According to a further aspect of the present disclosure is to provide a developing device comprising: a developing container configured to accommodate a developer containing toner and a carrier; and a developer carrying member including a rotatable sleeve and a magnet provided inside the sleeve, wherein the sleeve includes a developer carrying and conveying portion which is configured to carry and convey the developer to a developing position and which includes a groove portion which is a portion where a groove is formed and a non-groove portion where the groove is not formed, wherein in a case where a depth of the groove is D, a radius of the carrier is R, and a width of the groove in a rotational direction of the sleeve is W, D>R and W>2R are satisfied, and wherein each of the groove portion and the non-groove portion includes a chromium layer on an outer surface of the sleeve.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of an image forming apparatus according to a first embodiment.

FIG. 2 is a schematic cross-sectional view of a developing device according to the first embodiment.

FIG. 3 is a schematic longitudinal sectional view of the developing device according to the first embodiment.

FIG. 4 is a perspective view of a developing sleeve according to the first embodiment.

FIG. 5 is a schematic view for illustrating a shape of a groove formed on the developing sleeve according to the first embodiment.

FIG. 6 is a schematic view for illustrating another first example of the shape of the groove formed on the developing sleeve according to the first embodiment.

FIG. 7 is a schematic view for illustrating another second example of the shape of the groove formed on the developing sleeve according to the first embodiment.

Parts (a) and (b) of FIG. 8 are schematic views each for illustrating shape of a groove formed on the developing sleeve.

Parts (a) and (b) of FIG. 9 are schematic views each for illustrating a shape of a groove formed on the developing sleeve.

FIG. 10 is a schematic view for illustrating a conveying state of a developer on a surface of the developing sleeve.

FIG. 11 is a schematic view showing a periphery of the groove in an enlarged manner in order to illustrate the conveying state of the developer on the surface of the developing sleeve.

FIG. 12 is a graph showing a relationship between a temperature and viscosity of toner.

Part (a) of FIG. 13 is a schematic view for illustrating a sleeve ghost, part (b) of FIG. 13 is a schematic view showing a state in which unevenness of image due to the sleeve ghost occurs, and part (c) of FIG. 13 is a schematic view for illustrating measurement of image density due to the sleeve ghost.

FIG. 14 is a sectional view schematically showing a part of a surface of the developing sleeve according to the first embodiment in an enlarged manner.

FIG. 15 is a sectional view schematically showing a part of a surface of a developing sleeve according to a second embodiment in an enlarged manner.

FIG. 16 is a sectional view schematically showing a part of a surface of a developing sleeve according to a third embodiment in an enlarged manner.

### DESCRIPTION OF THE EMBODIMENTS

### First Embodiment

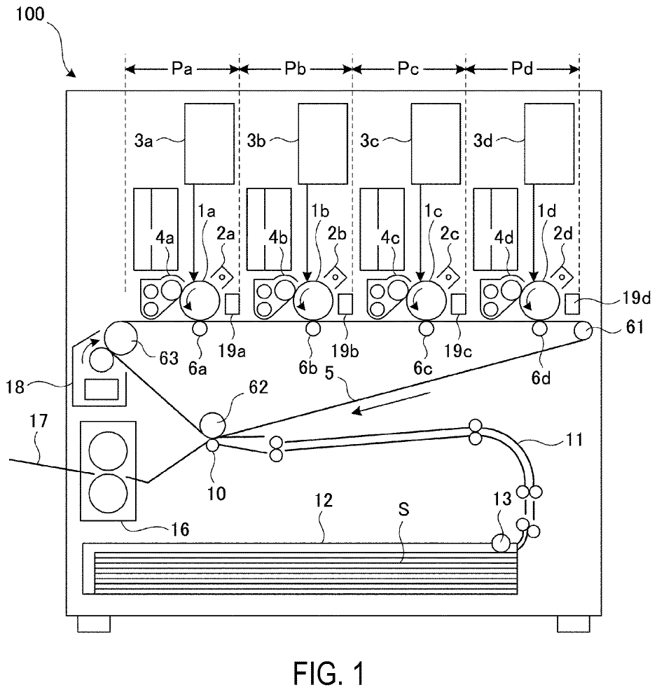

A first embodiment of the present disclosure will be described using FIG. 1 to FIG. 14. First, a schematic constitution of an image forming apparatus 100 of this embodiment will be described using FIG. 1. In this embodiment, as an example of the image forming apparatus 100, the case where a full-color printer of a tandem type is used will be described. Incidentally, as the image forming apparatus 100, a type thereof is not limited to the tandem type in which a plurality of image forming portions are arranged side by side, but may also be a rotary type in which the image forming portions are arranged in a cylindrical shape. Further, a transfer system of the image forming apparatus 100 is not limited to an intermediate transfer system in which a toner image is primarily transferred onto an intermediary transfer member and thereafter is secondarily transferred onto a recording material S, but may also be a direct transfer system in which the toner image is directly transferred from a photosensitive member onto the recording material S. Further, a color of the toner image is not limited to a full color, but may also be a monochromatic color or a monocolor, and these colors can be realized in various purposes, such as various printing machines, copying machines, facsimile machines, multi-function machines, and the like. The recording material S is, for example, a sheet, and includes, in addition to plain paper, special paper such as coated paper, special-shaped recording materials such as an envelope and index paper, and a plastic film for an overhead projector, a cloth, and the like.

### [Image Forming Apparatus]

The image forming apparatus 100 of this embodiment is a full-color image forming apparatus 100 employing an electrophotographic system, and includes for image forming portions Pa, Pb, Pc, and Pd. Incidentally, constitutions of the respective image forming portions are substantially the same except that developing colors are different from each other. For this reason, hereinafter, in the case where there is no need to particularly distinguish these portions, the image forming portion Pa is described as an representative, and other image forming portions will be omitted from detailed description by adding suffixes b, c, and D to numerals or symbols each showing a constituent element of an associated image forming portion.

The image forming portion Pa includes a photosensitive drum 1a as an image bearing member for bearing a toner image. The photosensitive drum 1a is an example of a photosensitive member for electrophotography, and is formed in a cylindrical shape. Such a photosensitive drum 1a is rotated in an arrow direction (counterclockwise direction) of FIG. 1. Around the photosensitive drum 1a, a charger 2a as a charging portion, a laser beam scanner 3a as an exposure device, a developing device 4a, a primary transfer roller 6a, a cleaning device 19a, and the like are provided.

Next, a surface of the photosensitive drum 1a is electrically charged uniformly to a predetermined charge potential by the charger 2a. The photosensitive drum 1a charged by the charger 2a subsequently subjected to scanning example to laser light, modulated by an image signal, by a laser beam scanner 3a which is an example of the exposure device.

The laser beam scanner 3a incorporates a semiconductor laser, and this semiconductor laser is controlled on the basis of input image data, and emits the laser light. For example, the semiconductor laser is controlled correspondingly to an original image information signal (image data) input from an original reading apparatus including a photoelectric conversion element or correspondingly to an image information signal input from an external terminal. By this, a surface potential of the photosensitive drum 1a charged by the charger 2a is changed in an image portion, so that an electrostatic latent image is formed on the photosensitive drum 1a. Incidentally, as a light source of the exposure device, the light source is not limited to the laser, but may also use an LED or an OLED, and is not limited to a scanning type, but may also use a two-dimensional or three-dimensional array light source.

The electrophotographic latent image thus formed on the photosensitive drum 1a is reversely developed with toner by the developing device 4a, so that a visible image, i.e., a toner image is formed. In this embodiment, the developing device 4a uses a two-component developing system using, as a developer, a developer including toner and a carrier.

That is, each of the developing devices 4a, 4b, 4c, and 4d accommodates the two-component developer containing the toner of an associated color. Specifically, toner of yellow (Y), toner of magenta (M), toner of cyan (C), and toner of black (K) are accommodated in the developing devices 4a, 4b, 4c and 4d, respectively. Accordingly, the above-described steps are performed for each of the image forming portions Pa, Pb, Pc, and Pd, whereby toner images of four colors of yellow, magenta, cyan, and black are formed on the photosensitive drums 1a, 1b, 1c, and 1d, respectively.

Further, in a position below the image forming portions Pa, Pb, Pc, and Pb, an intermediary transfer belt 5 which is an intermediary transfer member is provided. The intermediary transfer belt 5 is stretched by rollers 61, 62, and 63 and is made movable in an arrow direction. The toner images on the photosensitive drums 1a to 1d are successively transferred onto the intermediary transfer belt 5 by the primary transfer rollers 6a to 6d as a primary transfer member. By this, the toner images of the four colors of yellow, magenta, cyan, and black are superposed on the intermediary transfer belt 5 so that a full-color image is formed. Further, toner remaining on the photosensitive drum 1a without being transferred onto the intermediary transfer belt 5 is collected by the cleaning device 19a.

The full-color image on this intermediary transfer belt 5 is transferred, by the action of a secondary transfer roller 10, onto the recording material S such as a sheet (paper, OHP sheet, or the like) taken out from a feeding cassette 12 and conveyed through a feeding guide 11. Tone remaining on a surface of the intermediary transfer belt 5 without being transferred onto the recording material S is collected in an intermediary transfer belt cleaning device 18. On the other hand, the recording material S on which the toner image is transferred is sent to a fixing device 16, where an image is fixed, and the recording material S is discharged to a discharge tray 17.

### [Two-Component Developer]

The developer used in this embodiment is the two-component developer comprising non-magnetic toner and a magnetic carrier, and 8 weight parts of the non-magnetic toner is added to 92 weight parts of the magnetic carrier described later, followed by mixing, so that negatively charged toner can be obtained. In the following, respective components will be described specifically.

### [Toner]

The toner in this embodiment comprises a binder resin, a parting (release) agent, a colorant, and inorganic fine particles. As the binder resin, a crystalline resin and a non-crystalline (amorphous) resin are used in combination, and polyester resin is used. The polyether resin is easy to be designed to compatibly realize a fixing property and a charging characteristic, and can be suitably used.

The non-crystalline polyester is preferable from viewpoints of a low-temperature fixing property and abrasion resistance when a peak molecular weight thereof is 3,500 or more and 20,000 or less. In this embodiment, the non-crystalline polyester of 5,000 in the molecular weight was used. An acid value of the non-crystalline may preferably be 5 mgKOH/g or more and 30 mgKOH/g or less from a viewpoint of a charge maintaining property in a high-temperature/high-humidity environment. In this embodiment, the non-crystalline polyester of 5 mg/KOH/g or more in acid value was used. Further, a hydroxyl value of the non-crystalline polyester may preferably be 20 mgKOH/g or more and 70 mgKOH/g or less from viewpoints of the low-temperature fixing property and the charge maintaining property. In this embodiment, the non-crystalline polyester of 40 mgKOH/g in hydroxyl value was used.

A weight-average molecular weight of the crystalline polyester may preferably be 15,000 or more and 50,000 or less from a viewpoint of blooming suppression. In this embodiment, the crystalline polyester of 25,000 in weight-average molecular weight was used. A sum of the acid value and the hydroxyl value of the crystalline polyester may preferably be 0.1 mgKOH/g or more and 5.0 mgKOH/g or less from a viewpoint of crystallization. In this embodiment, the crystalline polyester of 2 mgKOH/g in the sum of the acid value and the hydroxyl value was used. A content ratio of the crystalline polyester in the binder resin may preferably be 80.0 weight % or more and 97.0 weight % or less. In this embodiment, the content ratio of the crystalline polyester in the binder resin was 90 weight %.

As the parting agent, hydrocarbon wax such as paraffin wax or Fischer-Tropsche wax is suitably used. A content of the parting agent may preferably be 2 weight parts or more and 10 weight parts or less per 100 weight parts of the binder resin. A melting point of the parting agent may preferably be 60° C. or more and 120° C. or less, and in this embodiment, the parting agent of 76° C. in melting point was used.

As the coloring agent, it is possible to cite a colorant colored in black by using carbon black as a black colorant, a yellow colorant, a magenta colorant, and a cyan colorant. As the colorant, a pigment may be used singly or may be used in combination with a dye. A content of the colorant may preferably be 0.1 weight part or more and 30.0 weight parts or less per 100 weight parts of the binder resin. In this embodiment, 7 weight parts of the carbon black was added.

A toner resin used in this embodiment is prepared by the above-described method, and the toner resin including a toner base resin having a softening point temperature Tm of 105° C. is used. For measurement of the softening point Tm, a capillary rheometer of constant-load extrusion type “Flow Characteristic Evaluation Apparatus, Flowtester CFT-500D” (manufactured by Shimadzu Corporation) is used, and the measurement is performed in accordance with a manual accompanying the apparatus.

The inorganic fine particles are used for adjusting flowability/chargeability by being deposited as an external additive to the toner surface. As the inorganic fine particles, it is possible to cite fine particles such as silica fine particles, titanium oxide fine particles, alumina fine particles, or double oxide fine particles of these fine particles. Of these inorganic fine particles, the silica fine particles and the titanium oxide fine particles are preferred for flowability improvement and chargeability uniformization. The inorganic fine particles may preferably be hydrophobized by a hydrophobizing agent, such as a silane compound, silicone oil, or a mixture of these compounds, from a viewpoint of improving a depositing force to toner base material particles. A content of the external additive may preferably be 0.3 weight part or more and 10.0 weight part or less per 100 weight parts of the toner base material particles. In this embodiment, 1.0 weight part of silica fine particles of 10 nm in average particle size, 2.0 weight parts of silica fine particles of 100 nm in average particle size, and 0.7 weight part of titanium oxide fine particles of 45 mm in average particle size are added.

A manufacturing method of the toner particles is not particularly limited, and a known method such as a pulverization method, a suspension polymerization method, a dissolution suspension method, as emulsion aggregation method, a dispersion polymerization method, or the like can be used. In this embodiment, the toner was prepared by the pulverization method. A volume-average particle diameter (D4) of the toner may preferably be 5 μm or more and 10 μm or less, and the toner of 5.8 μm in D4, and D4 was measured by “CDA-1000X”, (aperture diameter: 100 μm, manufactured by Sysmex Corporation).

### [Magnetic Carrier]

A magnetic carrier (hereinafter, simply referred to as a “carrier” in some cases) in this embodiment is magnetic carrier particles including magnetic core particles and a coating resin layer for coating surfaces of the magnetic core particles. As the magnetic core particles of the magnetic carrier according to this embodiment, conventional magnetic material particles such as ferrite or magnetite can be used. Further, it is possible to use magnetic core particles in the form such that resin is filled in ferrite or magnetite particles having pores can be used. Of these, the magnetic core in the form such that the resin is filled in the magnetic material particles having the pores is preferred from a viewpoint such that a magnetization level of the magnetic carrier can be made small. Further, by changing a composition ratio of the metal oxide as a raw material, it is possible to obtain ferrite having a desired magnetization level.

The magnetic core particles may preferably have an average particle diameter (D50) of 20 μm or more and 80 μm or less from viewpoints that a coating resin can be uniformly coated and that density of magnetic brush (chain) for realizing prevention of magnetic carrier deposition and obtainment of a high quality image is made appropriate.

In the coating resin layer, inorganic fine particles of 50 nm or more and 200 nm or less in number-average particle diameter may be contained. By forming minute unevenness on the surface of the carrier, an effect of reducing a depositing force onto the toner can be expected. As the inorganic fine particles, it is possible to cite fine particles such as silica fine particles, titanium oxide fine particles, alumina fine particles, or double oxide fine particles of these fine particles. The average particle diameter (D50) of the carrier was 40 μm, and was measured by “Microtrac MT3300EX” (manufactured by Nikkiso Co., Ltd.). Incidentally, in the coating resin layer of the carrier used in this embodiment, two kinds of coating resin including one containing no inorganic fine particles (used in this embodiment and in comparison examples 1 and 2 described later) and one containing silica fine particles of about 70 μm as the inorganic fine particles (used in comparison example 3 and in embodiments described later). By using the toner and each of the above-described carriers, a two-component developer was obtained by adding 8 weight parts of the toner to 92 weight parts of the magnetic carrier in mixture.

### [Developing Device]

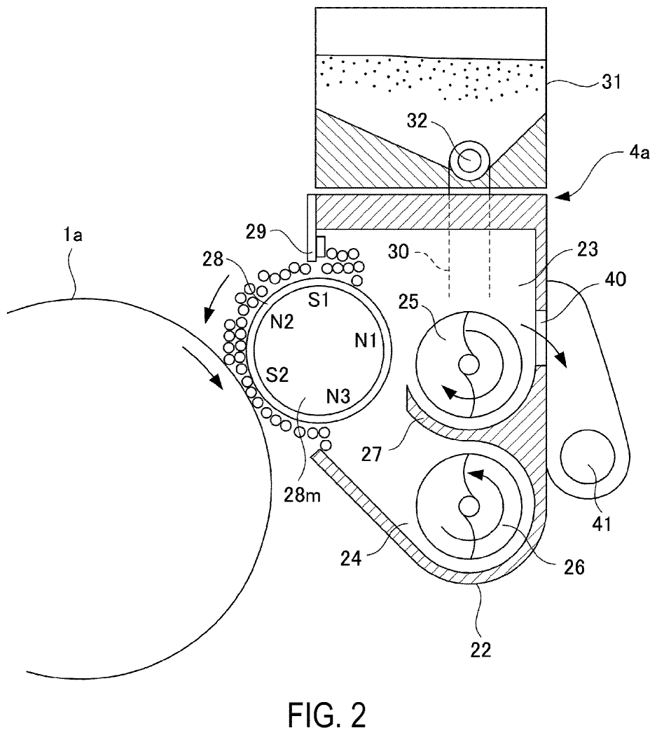

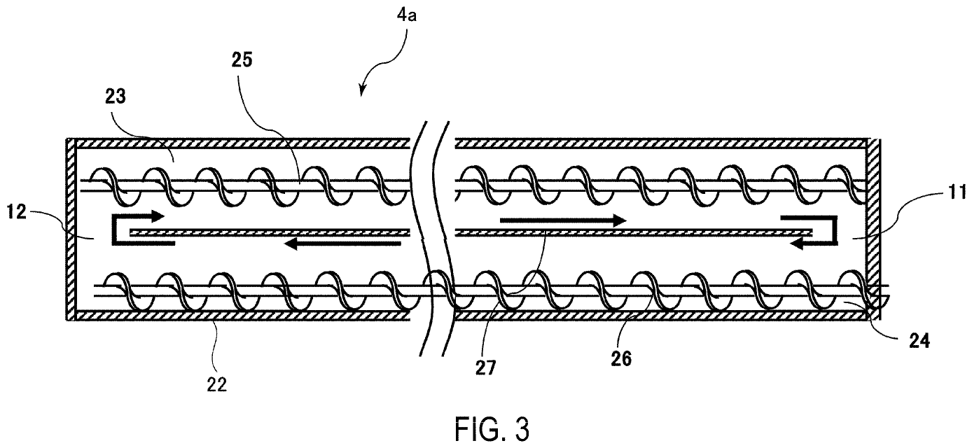

Next, the developing device 4a will be described with reference to FIGS. 2 and 3. Other developing devices 4b to 4d have the same constitution as the constitution of the developing device 4a, and therefore will be omitted from description. The developing device 4a includes a developing container 22 for accommodating the two-component developer, a developing sleeve 28 as a developer carrying member, and first and second conveying screws 25 and 26 as conveying members. Further, the developing device 4a of this embodiment has a constitution of a vertical stirring type in which an inside the developing container 22 is vertically partitioned in the developing chamber 23 as a first chamber and a stirring chamber 24 as a second chamber in a substantially (vertically) central portion thereof by a partition wall 27 extending along a rotational axis direction of the developing sleeve 28. The developer is accommodated in the developing chamber 23 and the stirring chamber 24.

Incidentally, above the developing container 22, a developer supplying portion 31 is provided. In the developer supplying portion 31, a developer for supply is accommodated, and a developer supplying screw 32 is rotated, so that the developer for supply is supplied into the developing container 22 through a supply passage 30. Further, in a side wall of the developing container 22, a developer discharge opening 40 is formed, and an excessive developer in the developing container 22 is discharged through the discharge opening 40 and is collected in an unshown collecting container by being conveyed by a discharging screw 41.

In the developing chamber 23 and the stirring chamber 24, the first and second conveying screws 25 and 26 are disposed, respectively. The first conveying screw 25 is disposed in a bottom of the upper-side developing chamber 23 so as to extend along and substantially parallel to the rotational axis direction of the developing sleeve 28, and conveys the developer in the developing chamber 23 in one direction along the rotational axis direction while stirring the developer by being rotated clockwise in FIG. 2. Further, the second conveying screw 26 is disposed in a bottom of the lower-side stirring chamber 24 so as to extend substantially parallel to the first conveying screw 25, and is rotated counterclockwise in FIG. 2 in a direction opposite to a rotational direction of the first conveying screw 25. Further, the second conveying screw 26 conveys the developer in the stirring chamber 24 long the rotational axis direction while stirring the developer in the direction opposite to the rotational direction of the first conveying screw 25.

Thus, by conveyance of the developer by rotations of the first and second conveying screws 25 and 26, the developer is circulated between the developing chamber 23 and the stirring chamber 24 through openings (i.e., communicating portions) 11 and 12 in opposite end portions of the partition wall 27.

An opening is formed in a position of the developing container 22, corresponding to a developing region opposing the photosensitive drum 1a, and the developing sleeve 28 is rotatably provided so as to be partially exposed to this opening toward the photosensitive drum 1a side. The developing sleeve 28 carries and conveys the developer accommodated in the developing container 22, and supplies the developer to a developing position of the photosensitive drum 1a. The developing sleeve 28 is contained by a non-magnetic material comprising an aluminum alloy.

Inside the developing sleeve 28, a magnet roller 28m as a magnet for carrying the developer on a surface of the developing sleeve 28 is provided non-rotationally. On a side upstream of a position, with respect to the rotational direction of the developing sleeve 28, where the developing sleeve 28 opposes the photosensitive drum 1a, a regulating blade 29 as a regulating member for regulating a layer thickness of the developer carried on the developing sleeve 28 is provided opposed to an outer peripheral surface of the developing sleeve 28. In this embodiment, the regulating blade 29 is disposed above the developing sleeve 28 with a predetermined gap to the outer peripheral surface of the developing sleeve 28.

The magnet roller 28m includes a developing pole S2 opposing the developing region and for carrying the developer on the developing sleeve 28 during development and magnetic poles S1, N1, N2, and N3 for carrying and conveying the developer, and is fixed inside the developing sleeve 28 in a non-rotation state. Particularly, the magnetic pole S1 as a first magnetic pole is a magnetic pole opposing the regulating blade 29 through the developing sleeve 28. Further, on a side upstream of the regulating pole S1 with respect to the rotational direction of the developing sleeve 28, the magnetic pole N3 and the magnetic pole N1 which are the same pole and disposed adjacently to each other. The magnetic poles N3 and N1 are disposed on a more inside of the developing container 22 than other magnetic poles are, and are constituted so that the developer is scraped off from the developing sleeve 28 by formation of a repelling magnetic field between these magnetic poles N3 and N1 and the scraped developer is collected in the stirring chamber 24.

The regulating blade 29 is constituted by a non-magnetic member formed of metal such as a plate-like aluminum alloy extending along a rotational axis of the developing sleeve 28 and is disposed on a side upstream of the position, opposing the photosensitive drum 1a, with respect to the rotational direction of the developing sleeve 28 as described above. Further, both the toner and the carrier pass through between a leading end portion of the regulating blade 29 and the developing sleeve 28, and are sent toward a developing portion.

A developer amount of the developer conveyed to the developing portion is adjusted as a developer amount of the developer carried on the developing sleeve 28 by a magnetic force of the magnet roller 28m by adjusting a gap of the regulating blade 29 with the surface of the developing sleeve 28. In this embodiment, by the regulating blade 29, a developer coating amount per unit area of the developer on the developing sleeve 28 is regulated to 30 mg/cm², for example. Further, the regulating blade 29 and the developing sleeve 28 are set to 200 to 1000 μm, preferably 300 to 700 μm, in gap therebetween. In this embodiment, the gap was set to 400 μm.

### [Constitution of Developing Sleeve]

Next, a constitution of the developing sleeve 28 will be described further specifically. The developing sleeve 28 is constituted by a non-magnetic material comprising an aluminum alloy, and the surface thereof is subjected to roughening processing for improving a conveying property of the developer. That is, in this embodiment, the developing sleeve 28 is made of the aluminum alloy. As the roughening processing, although it is possible to cite blast processing (see, for example, Japanese Patent Application Publication Nos. Hei 1-5711 and Hei 1-32506) in which fine hard particles are blasted onto the surface of the developing sleeve 28, knurling (processing) (see, for example, JP-A No. Sho 54-79043) in which an uneven shape is formed on the surface of the developing sleeve 28 by cutting (processing) or rolling (processing), and the like processing, the knurling excellent in abrasion resistance has becomes mainstream with lifetime extension of the developing device.

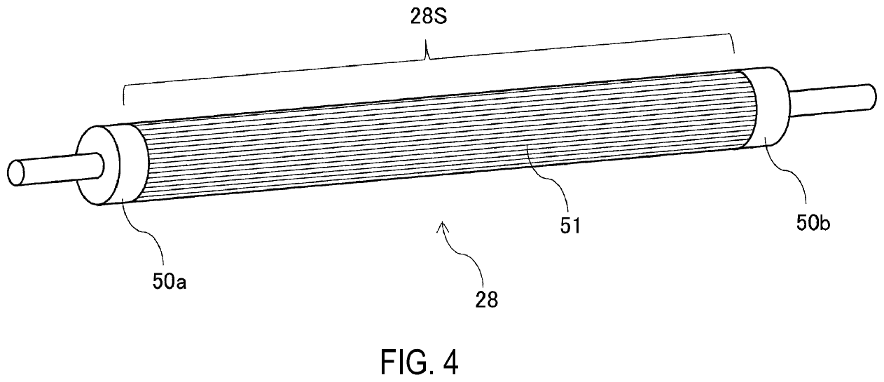

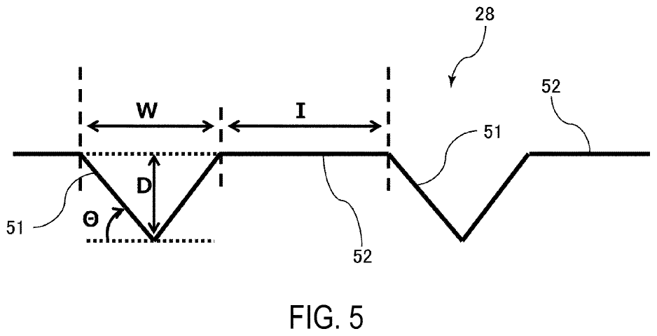

In this embodiment, as shown in FIG. 4, the developing sleeve 28 comprises the aluminum alloy (for example, A6063 (JIS H4100, JIS H4000)), and a plurality of grooves 51 for conveying the developer are formed in parallel on the surface thereof. The plurality of groove 51 are formed by, for example, straight knurling. FIG. 4 is a perspective view of the developing sleeve 28 of this embodiment, and FIG. 5 is a schematic view in which a part of the surface of the developing sleeve 28 is enlarged in a cross section cut in a direction perpendicular to the rotational axis direction of the developing sleeve 28 of this embodiment.

As shown in FIG. 4, in this embodiment, the plurality of the grooves 51 are formed in 72 lines parallel to each other with respect to the rotational axis direction of the developing sleeve 28 over a full circumference of a region 28S (a developer carrying and conveying portion for carrying and conveying the developer containing the toner and the carrier to the developing position) which is a surface for carrying and conveying the developer inside opposite ends of the developing sleeve 28 by 10 mm. That is, the region 28S (developer carrying and conveying portion) of the surface of the developing sleeve 28 includes a groove portion which is a portion where the grooves 51 are formed and a non-groove portion which is a portion where the grooves 51 are not formed. In each of regions (metal ring portions) 50a and 50b each of 10 mm from associated one of the opposite ends of the developing sleeve 28 with respect to the rotational axis direction, the grooves 51 are not formed. That is, the plurality of grooves 51 are formed over a circumferential direction of the developing sleeve 28 in the region 28S on the other end side than the region 50a of one end portion of the outer peripheral surface of the developing sleeve 28 with respect to the rotational axis direction and on one end side than the region 50b of the other end portion of the outer peripheral surface of the developing sleeve 28 with respect to the rotational axis direction. In each of the regions 50a and 50b, a gap between the opening of the developing container 22 and the developing sleeve 28 is sealed. A sealing method may be contact of a sealing agent with the regions 50a and 50b or may also be such that a sheet-like magnet is provided and sealed with a magnetic brush.

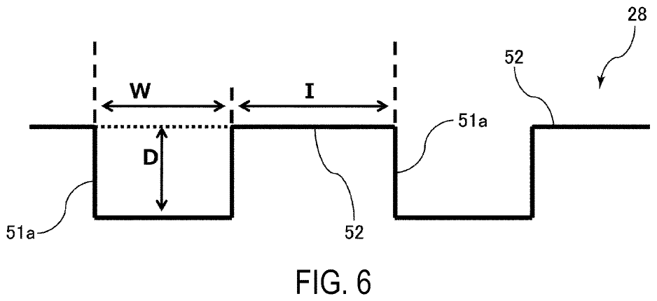

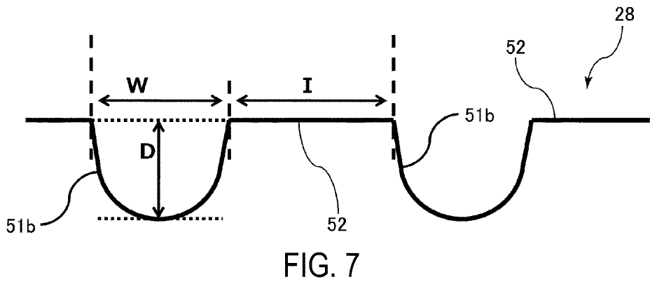

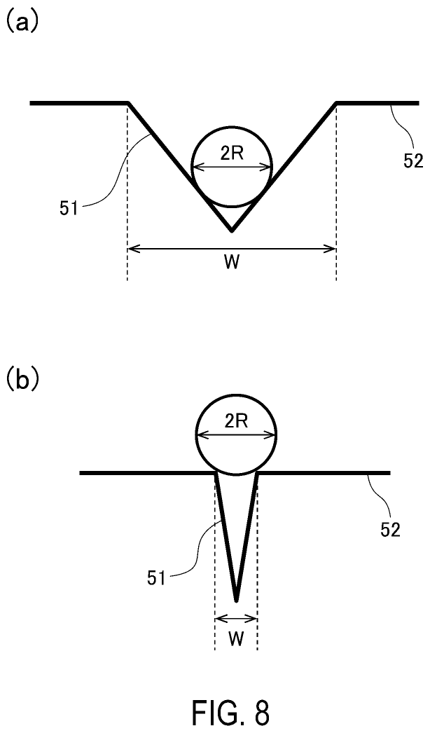

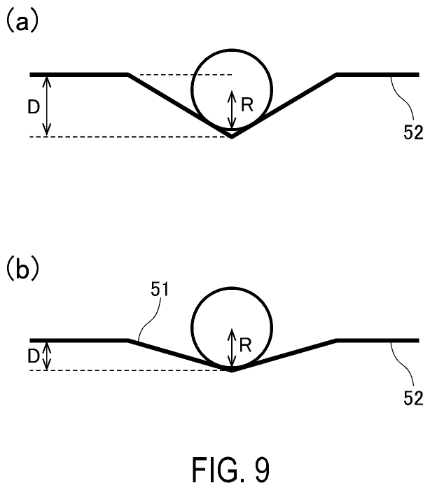

As shown in FIG. 5, in this embodiment, the plurality of grooves 51 are formed in 72 lines each in parallel to the rotational axis so that each groove 51 has a bilaterally symmetrical V-character shape with a depth D=60 [μm] and a width W=156 [μm] with respect to the rotational direction of the developing sleeve 28 and so that an interval I between adjacent grooves 51 and 51 on the developing sleeve 28 becomes about I=717 [μm]. Further, an angle θ of the V-character shape of each groove 51 is about 40°. A cross-sectional shape of each groove 51 is not limited to the V-character shape if only the developer is caught and conveyed by an associated portion thereof. For example, the cross-sectional shape may be a cross-sectional shape having a substantially flat bottom and a pair of substantially flat and parallel side walls as in each groove 51a which is another first example shown in FIG. 6 or may be a U-character shape as the cross-sectional shape in which a bottom is curved as in each groove 51b which is another second example shown in FIG. 7. Further, the plurality of grooves 51 formed in the region 28S (developer carrying and conveying portion) of the surface of the developing sleeve 28 may also have a twill line pattern with two kinds of angles crossing each other with respect to the rotational axis direction. However, even in any shape, the shape is such that at least one of carriers enter each groove 51 so that the carrier is caught by the groove 51. For this reason, each groove 51 may preferably satisfy (depth D of groove 51)>(radius R of carrier), and (width W of groove 51)>(diameter 2R of carrier).

Here, details of the shape of the grooves 51 formed on the developing sleeve 28 will be described.

In order to catch the developer, i.e., the magnetic carrier which is a bearer of conveyance of the developer in the groove 51, as shown in part (b) of FIG. 8, the width W of the groove 51 may be made wider than the diameter 2R of the magnetic carrier. This is because as shown in part (b) of FIG. 8, in the case where the width W of the groove 51 is narrower than the diameter 2R of the magnetic carrier, the magnetic carrier does not fall within the groove 51 irrespective of the depth of the groove 51 and catching of the magnetic carrier in the groove 51 is not caused.

Further, as shown in part (a) of FIG. 9, the depth D of the groove 51 may be made deeper than at least the radius R of the magnetic carrier. This is because as shown in part (b) of FIG. 9, in the case where the depth D of the groove 51 is shallower than the radius R of the magnetic carrier, a degree of catching of the magnetic carrier in the groove 51 is small and the catching of the magnetic carrier in the groove 51 is weak, and thus the magnetic carrier is liable to slide.

Further, the width W of the groove 51 may preferably be narrower than a width (20R) corresponding to 10 magnetic carriers. This is because in the case where the width W of the groove 51 is wider than the width (20R) corresponding to the 10 magnetic carriers, there is a possibility that the magnetic carrier is not readily caught in the groove 51 and an effect of a magnetic carrier conveying property by the groove 51 cannot be sufficiently obtained.

Accordingly, the following formulas (1) and (2) may be satisfied.

20R>W>2R (1), and

D>R (2).

Incidentally, when the depth D of the groove 51 is deeper than the radius R of the magnetic carrier, sufficient catching can be obtained, and furthermore, by setting the depth D so as to be deeper than the diameter 2R of the magnetic carrier, a whole of the magnetic carrier is caught in the groove 51, and therefore, the magnetic carrier is prevented from sliding out from the groove 51. For that reason, it is preferable that D>2R is satisfied.

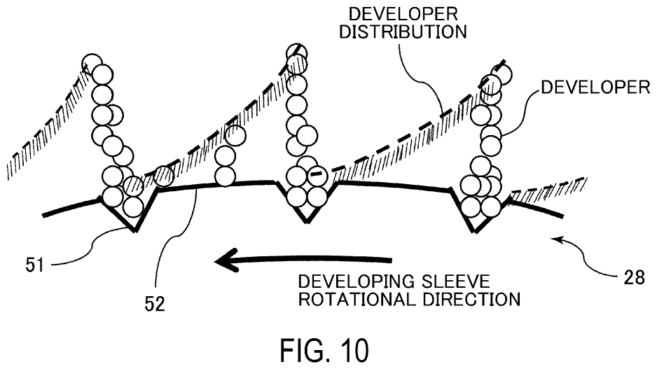

FIG. 10 is a schematic view showing a state during conveyance of the developer on the developing sleeve 28. A broken line of FIG. 10 represents a developer distribution on the developing sleeve 28, and a circle represents the carrier of the developer. However, in FIG. 10, all the carriers are not illustrated. The developer is mainly constrained in the grooves 51. The developer particles positioned between the groove 51 and the groove 51 (developer particles positioned on a projected portion 52) receive a force by the magnetic brush constrained in the groove 51 on an upstream side with respect to a conveying direction, and is conveyed in a pushing-out state. The projected portion 52 is a non-groove portion which is a portion where the grooves 51 are not formed.

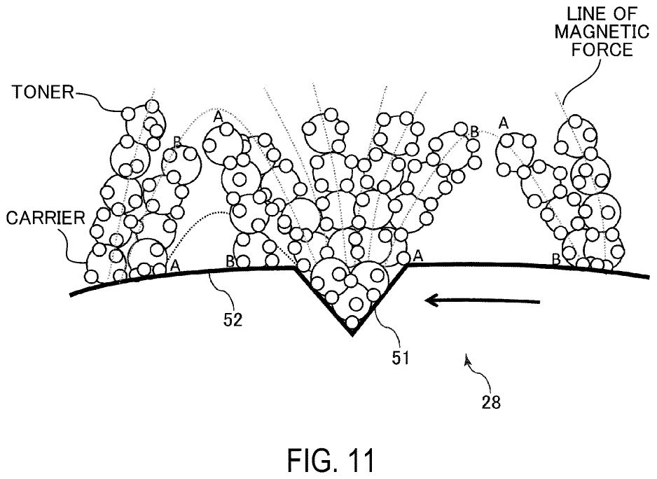

Further, as shown in FIG. 11, developer particles constrained by the grooves 51 and developer particles pushed out by the magnetic brush and positioned on the projected portion 52 (non-groove portion) are also changed in shape so as to extend along lines of magnetic force formed by the magnet roller 28m, and are conveyed while replacing an upper end A and a lower end B of the magnetic brush with each other. At this time, the toner carried on the carrier directly contact the surface of the developing sleeve 28, and in the case where a depositing force between the developing sleeve 28 and the toner is larger than a depositing force between the carrier and the toner, the toner which should be originally carried by the carrier is directly deposited on the developing sleeve 28. A force exerted on the toner is complicatedly changed depending on a direction in which the force is applied, a place where the force is applied, and a shape of the toner, so that it is difficult to mention generally the force exerted on the toner, but there is a tendency that roughly, the toner is liberated from the carrier and is deposited singly onto the developing sleeve 28 with a smaller depositing force between the carrier and the toner and with a larger depositing force between the developing sleeve 28 and the toner. This tendency becomes more conspicuous due to softness of the toner itself in the case where a low-melting point toner enabling low-temperature fixation. Thus, with rotation of the developing sleeve 28, on the surface of the developing sleeve 28, the toner deposited on the developing sleeve (hereinafter, also referred to as sleeve deposition toner) is formed.

Incidentally, in this embodiment, the toner becomes toner realizing a sharp melt property by using crystalline polyester and aims at maintaining hardness of the toner in a normal-temperature range while realizing the low-temperature fixation.

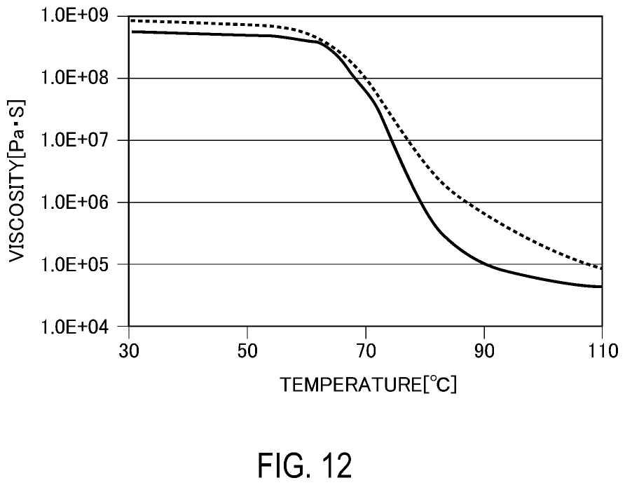

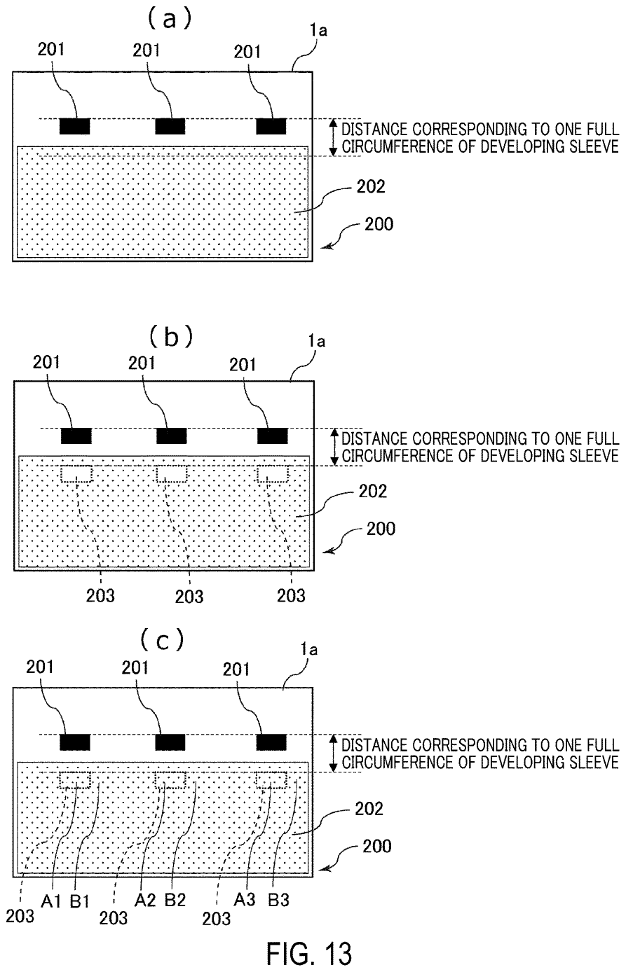

Here, a relationship between the temperature and viscosity of the toner will be described using a graph of FIG. 12. A solid line in FIG. 12 indicates a viscosity characteristic of the toner used in this embodiment. On the other hand, a dotted line in FIG. 12 indicates a viscosity characteristic of toner using no crystalline polyester. It is understood that the toner using the crystalline polyester in this embodiment is abruptly changed in viscosity from the normal-temperature range (30 to 50° C.) to a fixing range (viscosity: about 1.0E+05 Pa·S). A temperature when the viscosity becomes 1.0E+05 Pa·S is 90° C. for the toner used in this embodiment and 108° C. for the toner using no crystalline toner. For this reason, it can be said that the toner used in this embodiment becomes toner capable of being fixed at a lower temperature by about 18° C. On the other hand, as regards the viscosity of the toner used in this embodiment in the normal-temperature range, the toner used in this embodiment is the toner intended to realize the sharp melt property and therefore, although a difference in viscosity of the toner used in this embodiment from that of the toner containing no crystalline polyester is small, the fact is that the viscosity of the toner used in this embodiment in the normal-temperature range becomes somewhat low when compared with the toner containing no crystalline polyester. By this, the toner used in this embodiment becomes soft in the normal-temperature range when compared with the toner containing no crystalline polyester and becomes a state in which the toner used in this embodiment is liable to be deposited on the developing sleeve 28. There is a tendency that this phenomenon becomes more conspicuous for the toner intended to realize a larger effect of the low-temperature fixability by using the low-melting point toner enabling the low-temperature fixation.

### [Constitution of Developing Region]

A developing region is formed by providing the developing sleeve 28 so as to oppose the photosensitive drum 1a with a predetermined gap (SD gap), and the developing sleeve 28 is rotated in an arrow direction (counterclockwise direction) in FIG. 2 during the development. Then, the developing sleeve 28 carries the two-component developer regulated in layer thickness by the regulating blade 29 and conveys the two-component developer to the developing region opposing the photosensitive drum 1a, whereby the developing sleeve 28 supplies the developer to the electrostatic latent image formed on the photosensitive drum 1a. To the developing sleeve 28, a developing bias voltage in the form of a negative DC voltage Vdc biased (superposed) with an AC voltage is applied, and by a potential difference thereof with the photosensitive drum 1a, the toner is flied from the developer carried on the surface of the developing sleeve 28 onto the electrostatic latent image on the photosensitive drum 1a, so that the electrostatic latent image is developed by the toner.

In a digital latent image system which currently becomes mainstream, density gradation is prepared by changing an area ratio (and arrangement pattern) of a dot or a line with a certain density. Therefore, in a potential Vdr on the photosensitive drum 1a, a latent image potential (image portion latent potential Vl) of an image portion, for forming the dot or the line by being developed on the photosensitive drum 1a with the toner and a latent image potential (white background portion latent potential Vd) of a white background portion which is not developed on the photosensitive drum 1a with the toner exist. The DC voltage component Vdc of the developing bias (voltage) applied to the developing sleeve 28 is set to a value between the image portion latent image potential Vl and a white background portion latent image potential Vd. At this time, the AC voltage component of the developing bias has the action of scraping off the toner from the carrier and supplying the toner other than a port thereof at a tip of the magnetic brush contacting the photosensitive drum 1a to a developing step.

In this embodiment, the white background portion latent image potential Vd is set to −800 V by the charger 2a, and the image portion latent image potential Vl is set to −440 V by exposing the image portion to the laser beam at certain intensity by the laser beam scanner 3a. The DC voltage Vdc applied to the developing sleeve 28 is −640 V, and the AC voltage was applied intermittently with an amplitude of 1400 V for a time corresponding to two cyclic periods. An AC waveform is a rectangular wave, and in a time between adjacent AC waveforms (hereinafter, referred to as a blank time), the voltage consisting only of the Vdc is applied, and the blank time was set to 0.3 ms in this embodiment.

Further, an outer diameter of the developing sleeve 28 was set to 20 mm, an outer diameter of the photosensitive drum 1a was set to 30 mm, and the SD gap was set to 300 μm. Further, by an unshown driving device such as a motor, the photosensitive drum 1a is rotated so that a surface speed thereof becomes 435 mm/s, and the developing sleeve 28 is rotated so that a surface speed thereof becomes 740 mm/s which is about 1.7 times the surface speed of 435 mm/s of the photosensitive drum 1a. Here, the surface speed of the photosensitive drum 1a is substantially equal to a surface speed of the intermediary transfer belt 5 and a conveying speed of the recording material S, and is referred to as an image forming speed. The developing bias waveform, dimensions of the developing sleeve 28 and the photosensitive drum 1a, and the above-described values of the rotational speeds are examples of this embodiment, and the present disclosure is not limited thereto.

By making the above-described settings, the toner contained in the developer carried on the surface of the developing sleeve 28 is scraped off from the carrier in the developing region by the AC voltage, and by the DC voltage Vdc of the negative polarity, the polarity of the toner becomes the positive polarity relative to the white background portion latent image potential Vd on the photosensitive drum 1a and becomes the negative polarity relative to the image portion latent image potential Vl on the photosensitive drum 1a, so that the toner is flied onto the photosensitive drum 1a for the image portion latent image potential Vl and is flied onto the developing sleeve 28 for the white background portion latent image potential Vd. Here, a potential difference between the white background portion latent image potential Vd and the developing DC voltage Vdc (hereinafter, this potential difference is referred to as Vback) is a potential difference necessary to prevent toner deposition onto the white background portion on the photosensitive drum 1a in the case where a developing bias voltage in the form of the DC voltage biased with the AC voltage is used, and may preferably be 100 V or more. In this embodiment, the potential difference (Vback) is set to 160 V.

### [Sleeve Ghost]

As described above, when the toner is liberated and deposited singly on the developing sleeve 28, at the time when the sleeve deposition toner reaches the developing region, depending on a potential difference between the potential Vdr on the photosensitive drum 1a and the potential Vdc on the developing sleeve 28 (Vdr−Vdc, hereinafter referred to as a contrast potential difference), a toner amount of the toner deposited on the developing sleeve 28 is fluctuated, so that unevenness of the image becomes a problem due to this fluctuation in some cases.

This unevenness of the image roughly occurs through the following process. First, as described above, the sleeve deposition toner is formed on the surface of the developing sleeve 28 with rotation of the developing sleeve 28. Next, when the sleeve deposition toner reaches the developing region with the rotation of the developing sleeve 28, the sleeve deposition toner receives an electrostatic force by the contrast potential difference in the developing region, so that an amount of the sleeve deposition toner after passage through the developing region is fluctuated compared with an amount of the sleeve deposition toner before the passage through the developing region. Usually, the potential Vdc is always a certain value, but the potential Vdr is formed by the electrostatic latent image, so that the above-described contrast potential difference is different depending on a position of the photosensitive drum 1a with respect to a longitudinal direction (rotational axis direction) and a position of the photosensitive drum 1a with respect to a circumferential direction.

In such a case, even when the sleeve deposition toner before the passage through the developing region is uniform over the rotational axis direction of the developing sleeve 28 (hereinafter, this rotational axis direction is simply referred to as a rotational axis direction in some cases), the sleeve deposition toner after the passage through the developing region provides a difference depending on a difference of the contrast potential difference in the developing region with respect to the rotational axis direction. In the case of this embodiment, the toner has the negative polarity and is used in the two-component developing method, and therefore, the contrast potential difference (Vl−Vdc) becomes positive in the image portion where the toner is flied onto the photosensitive drum 1a, and on the other hand, becomes negative in the white background portion where the toner is returned to the developing sleeve 28. The toner in the developing region receives a force toward the photosensitive drum 1a side in the case where the contrast potential difference is positive and receives a force toward the developing sleeve 28 side in the case where the contrast potential difference is negative.

For this reason, in the rotational axis direction, in the case where there is a difference in contrast potential difference, an amount of the sleeve deposition toner corresponding to a negative contrast potential difference becomes larger than an amount of the sleeve deposition toner corresponding to a positive contrast potential difference. Strictly, the developing bias voltage is in the form of the DC voltage biased with the AC voltage, so that the toner on the developing sleeve 28 and the toner carried on the carrier are also reciprocated by the AC component. According to study by the present inventors, it is understood that the difference of the sleeve deposition toner with respect to the rotational axis direction is roughly determined by the above-described development contrast potential difference. That is, according to the study by the present inventors, it turned out that the above-described difference, with respect to the rotational axis direction, generating by passing through the developing region, i.e., the difference of the amount of the sleeve deposition toner, with respect to the rotational axis direction, after the passage through the developing region in the case where the amount of the sleeve deposition toner, with respect to the rotational axis direction, before the passage through the developing region was uniform is roughly determined by the amount of the sleeve deposition toner before the passage through the developing region and the difference, with respect to the rotational axis direction, of the contrast potential difference in the developing region, and that there is a tendency that the difference, with respect to the rotational axis direction, generating by the passage through the developing region becomes larger with a larger amount of the sleeve deposition toner before the passage through the developing region and with a larger absolute value of the difference of the contrast potential difference with respect to the rotational axis direction.

Accordingly, by the passage through the developing region, the amount of the sleeve deposition toner is fluctuated by an amount of the sleeve deposition toner in an arbitrary point on the developing sleeve 28 and an amount depending on the contrast potential difference, so that unevenness generates in amount of the sleeve deposition toner corresponding to the electrostatic latent image. In other words, the amount itself of the sleeve deposition toner before the passage through the developing region is provided by the contrast potential difference in preceding image formation, so that after all, unevenness generates in amount of the sleeve deposition toner corresponding to the electrostatic latent image in the developing region.

Thereafter, the sleeve deposition toner is conveyed on the developing sleeve 28 together with the developer, carried on the surface of the developing sleeve 28, with the rotation of the developing sleeve 28, so that the sleeve deposition toner reaches the developing region again after being subjected to the repelling magnetic field formed inside the developing container 22 and the layer thickness regulation by the regulating blade 29. At that time, the unevenness of the amount of the sleeve deposition toner is fluctuated so as to be uniformized by the above-described conveyance motion of the magnetic brush or retaining motion of the developer in the repelling magnetic field, and frictional sliding of the regulating blade 29 onto the surface of the developing sleeve 28. Then, when the sleeve deposition toner reaches the developing region again, in the case where the unevenness of the amount of the sleeve deposition toner formed last in the developing region is not sufficiently eliminated by uniformizing action with rotational motion of the developing sleeve 28 described above, the potential of the surface of the developing sleeve 28 is changed depending on a charge amount of the sleeve deposition toner.

In the case of this embodiment, the toner has the negative polarity and is of the two-component developing method, and therefore, when the amount of the sleeve deposition toner is large, the surface of the developing sleeve 28 becomes a more negative polarity, so that behavior such that as if the potential Vdc becomes large in the negative direction is performed. This substantially leads to an increase in contrast potential difference of the image portion. With a larger contrast potential difference of the image portion, an amount of development of the electrostatic latent image with the toner on the photosensitive drum 1a becomes larger, and therefore, the amount of the development with the toner is deviated from an originally intended amount of the development with the toner, depending on the amount of the sleeve deposition toner.

Here, an image pattern 200 such that solid image patches 201 (an area ratio of an image portion is maximum, an image with the area ratio of 100% is used here) with a maximum density corresponding to a maximum image signal value are disposed in the rotational axis direction adjacently to a white background portion and that a uniform half-tone image 202 is disposed in a position of one rotation (one full circumference) from a position of the solid image patches 201 in a sub-scanning direction will be considered. Part (a) of FIG. 13 are part (b) of FIG. 13 and part (c) of FIG. 13 which are described later are illustrates each schematically showing a toner image formed on the photosensitive drum 1a. As described above, there is a tendency that the difference of the amount of the sleeve deposition toner with respect to the rotational axis direction after the passing through the developing region becomes larger with a larger amount of the sleeve deposition toner before the passage through the developing region and with a larger absolute value of the difference of the contrast potential difference with respect to the rotational axis direction. For this reason, in the image pattern 200 shown in part (a) of FIG. 13, unevenness of the amount of the sleeve deposition toner is liable to generate, and is liable to appear as density unevenness. Part (b) of FIG. 13 shows a state in which unevenness of the amount of the development with the toner on the photosensitive drum 1a depending on the difference of the amount of the sleeve deposition toner with respect to the rotational axis direction remarkably generates, and density unevenness depending on an image before one full circumference of the developing sleeve 28 appears as an image pattern 203.

Such a phenomenon is a hysteresis phenomenon of the image pattern in terms of appearance of the image corresponding to a phase before one full circumference of the developing sleeve 28, and a main factor thereof is the sleeve deposition toner due to a depositing force between the developing sleeve 28 and the toner. For this reason, unevenness (image pattern 203 of part (b) of FIG. 13) of the amount of the development with the toner generated by the above-described phenomenon is hereinafter referred to as a sleeve ghost. As described above, the sleeve ghost occurs due to interrelationship among the sleeve deposition toner amount, the contrast potential difference in the developing region, the uniformizing action to the unevenness of the amount of the sleeve deposition toner with the rotation of the developing sleeve 28.

Here, in recent years, in a print-on-demand machine particularly used in commercial printing, in order to realize higher productivity, not only high-speed printing/high image quality but also high stability and energy saving have also been required. First, as regards the high stability, stability with time of a developer amount of the developer on the developing sleeve, which is one of important elements due to the nature of the electrophotographic system is improved. Conventionally, in order to convey the developer on the developing sleeve, the surface of the developing sleeve is provided with minute unevenness by being subjected to said blasting, so that a developer conveying force is imparted to the developing sleeve. However, this minute unevenness is abraded between the developing sleeve and the developer during use, and the unevenness becomes small with progression of use. As a result, developer conveying capacity on the developing sleeve lowers, and the amount of the developer carried by the developing sleeve becomes small.

In order to cope with this, in image forming apparatuses in recent years, as in this embodiment, a constitution in which the outer peripheral surface of the developing sleeve is provided with the plurality of grooves is employed. This constitution is prepared but cutting (processing) of grooves with a die through drawing, so that an amount of unevenness can be made large without deforming the developing sleeve. In this embodiment, the amount of the unevenness is large, and therefore, compared with the developing sleeve subjected to the sand blasting, the surface unevenness is not readily influenced by endurance abrasion, so that it becomes possible to convey the developer stably for a long-term use.

On the other hand, as regards the energy saving, improvement of the low-temperature fixability of the toner and reduction of energy consumed for fixing the image are attempted. However, when a softening point of the toner is simply made low, a lowering in storage stability of the toner influenced by heat during transportation and storage, and a durability lowering liable to cause toner deterioration such that external additive particles added to the toner surface are peeled off from the toner surface or embedded in the toner during image printing are caused. Therefore, as toner compatibly realizing the low-temperature and storage stability/durability, toner using crystalline polyester as a binder resin of the toner is proposed. This is because compared with conventional toner using only non-crystalline (amorphous) polyester as the binder resin, toner using the non-crystalline polyester and the crystalline polyester in combination not only has a characteristic such that the toner is abruptly softened approximately at a softening point, but also the crystalline polyester acts as a plasticizer for the non-crystalline polyester, and therefore, is an effective material for low-temperature fixation of the toner.

However, it turned out that in the case where the low-melting point toner as described above is used, a tendency such that the depositing force between the developing sleeve and the toner is high and the toner is liberated from the carrier and is deposited singly onto the developing sleeve when a developing sleeve carrying amount is adjusted by the layer thickness regulating member or when the developer is carried and conveyed on the surface of the developing sleeve. Thus, when the toner is deposited singly on the developing sleeve, depending on a charge amount of the deposited toner (sleeve deposition toner), the sleeve ghost as described above is caused to occur. In view of the above, as a countermeasure against the developing sleeve ghost due to this mechanism, it is desirable that a deposit amount difference due to image hysteresis of the toner deposited on the developing sleeve is reduced.

### Comparison Examples

Next, a result of evaluation of a sleeve ghost occurrence state in the case where kinds of the toner and the carrier are changed and a test image is output by using the developing sleeve 28 on which the plurality of grooves 51 are formed as described above will be described.

First, as a comparison example 1, toner using the non-crystalline polyester as the binder resin was used. As this toner, the toner having the viscosity indicated by the dotted line of FIG. 12 is used.

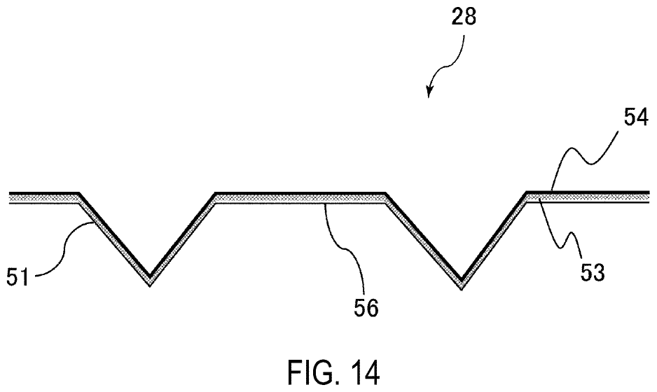

On the other hand, as a comparison example 2, toner using the crystalline polyester and the non-crystalline polyester as the binder resin was used. As this toner, the toner having the viscosity indicated by the solid line of FIG. 12 is used. Incidentally, in the comparison examples 1 and 2 and a comparison example 3 described later, as the developing sleeve 28, a constitution of this embodiment in which an outermost layer of an outer peripheral surface of the developing sleeve 28 is a chromium layer is not used, and a developing sleeve having a conventional constitution is used. Incidentally, details of the constitution of this embodiment in which the outermost layer of the outer peripheral surface of the developing sleeve 28 will be described later with reference to FIG. 14.

By using the toner of each of the above-described comparison examples 1 and 2 and the comparison example 3 described later, a test image in accordance with the above-described part (a) of FIG. 13 was prepared and an image was output. As regards the test image, a M0 light source setting of “eXact Standard” manufactured by Xrite Inc. was used as image density measurement setting, and a setting was made so that an image density of an image path with maximum density is 1.70±0.05 and that an image density of a half-tone image portion is 0.50±0.03. For an output image, an image quality was evaluated in accordance with evaluation criteria of a table 1 in the position described with reference to part (b) of FIG. 13.

TABLE 1

| Evaluation | Evaluation criteria |
|---|---|
| ⊚ | NOT CONFIRMED*¹ |
| ◯ | SLIGHTLY CONFIRMED*² |
| Δ | CONFIRMED*³ |
| X | CONFIRMED OVER SEVERAL TURNS*⁴ |

*¹Density unevenness is not confirmed in the position.
*²Slight density unevenness is confirmed in the position.
*³The density unevenness is confirmed in the position.
*⁴The density unevenness is confirmed over several turns (full circumferences) from the position.

For image output, a Bk station of an electrophotographic image forming apparatus “imagePRESS V1000” manufactured by CANON INC. was used. An environment in which the image forming apparatus was installed is a room temperature of 23° C. and a relative humidity of 50% RH, and as a sheet, a highly white paper sheet “GF-C081A4” available from Ca-non Marketing Japan Inc. was used. In a table 2, a result of evaluation of an image quality in each of the comparison examples 1 to 3 is shown.

TABLE 2

| | COMP. EX. 1 | COMP. EX. 2 | COMP. EX. 3 |
|---|---|---|---|
| TONER*¹ | CP | CP + NCP | CP + NCP |
| CARRIER COAT*² | NAP | NAP | SiPA |
| DEV. SLEEVE*³ | NCP | NCP | NCP |
| SLEEVE GHOST | ⊚ | Δ | X |

*¹“CP” is crystalline polyester. “CP + NCP” is (crystalline polyester) + (non-crystalline polyester).
*²“NAP” is no added particles. “SiPA” is Si particle addition.
*³“DEV.” is developing. “NCP” is no Cr plating.

As shown in table 2, as a result of comparison of test images for sleeve ghost, in the case where the toner using the crystalline polyester as the binder resin (comparison example 1), the sleeve ghost did not occur. However, it was confirmed that the toner using the crystalline polyester and the non-crystalline polyester in combination as the binder resin caused occurrence of the sleeve ghost over several full circumferences of the developing sleeve 28. This shows that in view of the above-described sleeve ghost mechanism and toner viscosity, compared with the toner using the crystalline polyester in the constitution of the comparison example 1, the toner using the crystalline polyester and the non-crystalline polyester in combination in the constitution of the comparison example 2 is soft in the normal-temperature range, and therefore, the sleeve deposition toner increases and the sleeve ghost becomes liable to appear.

Further, from a viewpoint of reduction of the depositing force between the developing sleeve 28 and the toner, an image quality was evaluated by using, as the comparison example 3, a constitution in which a developer containing the toner of the comparison example 1 and a carrier, containing 20 parts or more of silica fine particles as inorganic fine particles in a coating resin layer, in combination. This result is also shown in the table 2. As shown in the table 2, it turned out that in the comparison example 3, the sleeve ghost appears stronger than in the comparison example 2. This shows that by the presence particles having chargeability closer to that of the toner on the carrier surface, capacity of scraping off the toner by the carrier is locally lowered and an eliminating force of the image hysteresis by the rotation of the developing sleeve 28 is weakened.

### Constitution of this Embodiment

From the above-described result of study of the table 2, in this embodiment, as shown in FIG. 14, the surface of the developing sleeve 28 is provided with a chromium layer 54. That is, an outermost layer of the outer peripheral surface of the developing sleeve 28 is the chromium layer 54. The chromium layer 54 may preferably be 1 μm or more and 5 μm or less in thickness.

As described above, a factor of deposition of the sleeve deposition toner, causing the sleeve ghost, onto the developing sleeve 28 is a contrast potential difference, and as regards the amount of the sleeve deposition toner, sensitivity of contact resistance in the neighborhood of the developing sleeve 28 is high. In order to reduce the amount of the sleeve deposition toner, it is desirable that the contact resistance in the neighborhood of the developing sleeve 28 is reduced. In addition, the developing sleeve 28 is also required to have the stability as described above, it is desirable that the developing sleeve 28 is not changed with time. In order to stably lower the contact resistance, a metal layer of metal, such as gold or platinum, low in reactivity is used, or a thin layer of a passivation material such as chromium. The former is not appropriate for surface treatment of the developing sleeve 28 because of expensiveness and relative softness. Accordingly, in this embodiment, the chromium is coated on the surface of the developing sleeve 28, so that the contact resistance in the neighborhood of the surface of the developing sleeve 28 and thus reduction of the sleeve deposition toner is achieved.

The surface of the developing sleeve 28 in this embodiment is the chromium layer 54 as the outermost layer of the outer peripheral surface as shown in FIG. 14. That is, the developing sleeve 28 in this embodiment is prepared by forming a plurality of grooves 51 with a die on an outer peripheral surface of a bare tube 56 made of aluminum. Then, the outer peripheral surface of the bare tube 56 which is a base layer is appropriately subjected to preliminary treatment and masking, and then a metal underlayer 53 which is an adhesive layer is formed on the outer peripheral surface of the bare tube 56. The metal underlayer 53 is a layer of metal, and as the metal, nickel or copper is used. That is, on the outer peripheral surface of the bare tube 56, an electroless nickel plating layer (embodiment 1a and embodiment 1b described later) is formed or a copper plating layer (embodiment 1c described later) is formed by electroplating.

Thereafter, the chromium layer (metal surface layer 54 is formed on the outer peripheral surface of the metal underlayer 53. The chromium layer 54 is provided by forming a chromium plating layer on the outer peripheral surface of the metal underlayer 53 by electroplating. As a result of study by the present inventors, when a thickness of the chromium plating layer is 1 μm or more, amelioration of the sleeve ghost is confirmed. In this embodiment, a thickness of the chromium plating layer is 1.3 μm (embodiment 1a) or 4.4 μm (embodiment 1b, embodiment 1c).

For measurement of the layer thickness of the chromium layer 54, a fluorescent X-ray analyzer capable of nondestructive inspection is used in this embodiment. The measurement was performed by measuring spectrum intensity of CrKα ray under the following condition by a micro X-ray fluorescence analyzer (“ORBIS PC”, manufactured by AMETEK Inc.).
X-ray irradiation range: 30 μmφ
Analysis atmosphere: Ambient air
Tube voltage: 50 kV
Tube current: 250 μA
Filter: no

Spectrum intensity of the CrKα ray is measured by using a sample in which a thickness of the chromium layer 54 is known preliminarily by observation of a cross section through a scanning electron microscope and thus a calibration curve is prepared, so that a thickness of the chromium layer 54 is estimated from the spectrum intensity of the CrKα ray of the sample in this embodiment.

In this embodiment, by the above-described method, the thickness of the chromium layer 54 of the outermost layer of the outer peripheral surface of the projected portion 52 (non-groove portion) formed between the adjacent grooves 51 and 51 of the developing sleeve 28 was measured at six points in total consisting of three points of the developing sleeve 28 with respect to the rotational axis direction and three points of the developing sleeve 28 on a back side of thereof. The three points with respect to the rotational axis direction are a point of 10 mm in a direction of the region 50b from a boundary portion between the region 50a and the region 28S (developer carrying and conveying portion) in which the grooves 51 are formed, a point of a center of the region 28S (developer carrying and conveying portion) in which the grooves 51 are formed with respect to the rotational axis direction, and a point of 10 mm in a direction of the region 50a from a boundary portion between the region 50b and the region 28S (developer carrying and conveying portion) in which the grooves 51 are formed. Further, the measurement at each of the above-described three points in the rotational axis direction was performed in two positions in the circumferential direction of the developing sleeve. Specifically, the measurement was performed at the above-described three points in the rotational axis direction and at three points which are points rotated from the above-described three points in a circumferential direction of the developing sleeve 28 by 180°, i.e., the three points on the back side, and thus was performed at six points in total, and an average value of the measured values at these six points is employed as the thickness of the chromium layer 54 of the outermost layer of the outer peripheral surface of the projected portion 52 (non-groove portion) formed between the adjacent grooves 51 and 51 of the developing sleeve 28.

When the average value from these measured values is 1 μm or more, it is understood that the thickness of the chromium layer 54 which is the outermost surface layer of the outer peripheral surface of the projected portion 52 (non-groove portion) formed between the adjacent grooves 51 and 51 of the developing sleeve 28 is 1 μm or more.

Incidentally, in this embodiment, as a preparation method of the chromium layer 54, a relative inexpensive and simple plating was used, but a vacuum deposition method or the like may also be used. Further, the aluminum bare tube 56 is subjected to chromium plating (chromium layer 54), and then the plurality of grooves 51 may be prepared on the surface of the developing sleeve 28. Incidentally, details of this method in which the aluminum bare tube 56 is subjected to chromium plating (chromium layer 54) and then the plurality of grooves 51 are prepared on the surface of the developing sleeve 28 will be described later in a second embodiment.

In embodiments 1a, 1b, and 1c in which the developing sleeve 28 of this embodiment described above was used, test images were output under the same condition as that in the above-described comparison examples. A result is shown in a table 3 below. In the embodiment 1a, the thickness of the chromium layer 54 is 1.3 μm, and the metal underlayer 53 is the electroless nickel plating layer. In the embodiment 1b, the thickness of the chromium layer 54 is 4.4 μm, and the metal underlayer 53 is the electroless nickel plating layer. In the embodiment 1c, the thickness of the chromium layer 54 is 4.3 μm or less, and the metal underlayer 53 is a copper electroplating layer.

TABLE 3

| | COMP. EX. 2 | EMB. 1a | EMB. 1b | EMB. 1c |
|---|---|---|---|---|
| TONER*¹ | CP + NCP | CP + NCP | CP + NCP | CP + NCP |
| CC*² | NAP | NAP | NAP | NAP |
| DSSL*³ | CC | Cr(1.3 μm) | Cr(4.4 μm) | Cr(4.3 μm) |
| DSUL*⁴ | — | ENP | ENP | CEP |
| SG*⁵ | Δ | ⊚ | ⊚ | ⊚ |

*¹“CP” is crystalline polyester. “CP + NCP” is (contrast potential polyester) + (non-contrast potential polyester).
*²“CC” is carrier coat(ing). “NAP” is no added particles.
*³“DSSL” is a developing sleeve surface layer. “CC” is a conventional constitution. “Cr” is Cr plating.
*⁴“DSUL” is a developing sleeve under layer. “ENP” is the electroless nickel plating. “CEP” is the copper electroplating.
*⁵“SG” is the sleeve ghost.

As shown in the table 3, as in this embodiment, as regards the developing sleeve 28 including the chromium layer 54 as the outermost surface layer, it is understood that the sleeve ghost is alleviated compared with the comparison example 2 irrespective of a kind of the metal underlayer 53 which is an adhesive layer and the thickness of the chromium layer 54. Accordingly, as in this embodiment, it is understood that occurrence of the sleeve ghost can be suppressed when the outermost surface layer of the outer peripheral surface of the developing sleeve 28 is the chromium layer 54 and the thickness of the chromium layer 54 is 1 μm or more.

Further, in a table 4 blow, a result of comparison of constitutions of the above-described comparison example 3 and an embodiment 1d is shown. The embodiment 1d has a constitution in which in the constitution of the embodiment 1b, a carrier including 20 parts or more of silica fine particles which have the same polarity as a charge polarity of the toner and which are as inorganic fine particles of 50 nm or more and 200 nm or less in terms of a number-average particle diameter in a coating resin layer was used. Also, in the comparison example 3, as described above, the carrier including 20 parts or more of the silica fine particles as the inorganic fine particles in the coating resin layer is used.

TABLE 4

| | COMP. EX. 3 | EMB. 1d | EMB. 2 |
|---|---|---|---|
| TONER*¹ | CP + NCP | CP + NCP | CP + NCP |
| CC*² | SiPA | SiPA | SiPA |
| PR*³ | — | GP + NGP | NGP |
| DSSL*⁴ | — | Cr(4.4 μm) | Cr(4.2 μm) |
| DSUL*⁵ | — | ENP | ENP |
| SG*⁶ | X | ◯ | ◯ |

*¹“CP” is crystalline polyester. “CP + NCP” is (contrast potential polyester) + (non-contrast potential polyester).
*²“CC” is carrier coat(ing). “SiPA” is Si particle addition.
*³“PR” is a plating region. “GP” is the groove portion. “NGP” is the non-groove portion.
*⁴“DSSL” is a developing sleeve surface layer. “Cr” is Cr plating.
*⁵“DSUL” is a developing sleeve under layer. “ENP” is the electroless nickel plating.
*⁶“SG” is the sleeve ghost.

As shown in the table 4, in the case where the carrier containing 20 parts or more of the silica fine particles as the inorganic fine particles in the coating resin layer, although the sleeve ghost is liable to appear in the comparison example 3, it is understood that the occurrence of the sleeve ghost can be suppressed in the embodiment 1d. Accordingly, as in this embodiment, when the outermost layer of the outer peripheral surface of the developing sleeve 28 is the chromium layer 54, the occurrence of the sleeve ghost can be suppressed even when the carrier containing 20 parts or more of the silica fine particles as the inorganic fine particles in the coating resin layer.

As described above, the deposition of the toner on the developing sleeve 28 can be suppressed by using the chromium layer 54 as the outermost layer of the outer peripheral surface of the developing sleeve 28, and therefore, the occurrence of the sleeve ghost can be suppressed. Further, from a viewpoint of suppression of the occurrence of the sleeve ghost, it is preferable that the thickness of the chromium layer provided at the outermost layer (outer surface) of the outer peripheral surface of the developing sleeve 28 is made 1 μm or more. On the other hand, according to study by the present inventors, when the thickness of the chromium layer provided at the outer surface of the developing sleeve 28 is 5 μm, an effect of suppressing the occurrence of the sleeve ghost can be sufficiently achieved. From this, it is preferable that the thickness of the chromium layer provided at the outer surface of the developing sleeve 28 is made 5 μm or less from a viewpoint of suppressing manufacturing cost due to the chromium plating. Therefore, in this embodiment, the thickness of the chromium layer provided at the outer surface of the developing sleeve 28 is made 1 μm or more and 5 μm or less.

Therefore, according to this embodiment, the deposition of the toner onto the developing sleeve 28 can be suppressed at a low cost. Particularly, according to this embodiment, even in the case where low-melting point toner using the crystalline polyester as the binder resin of the toner, it becomes possible to suppress the sleeve ghost with a simple and in expensive constitution.

### Second Embodiment

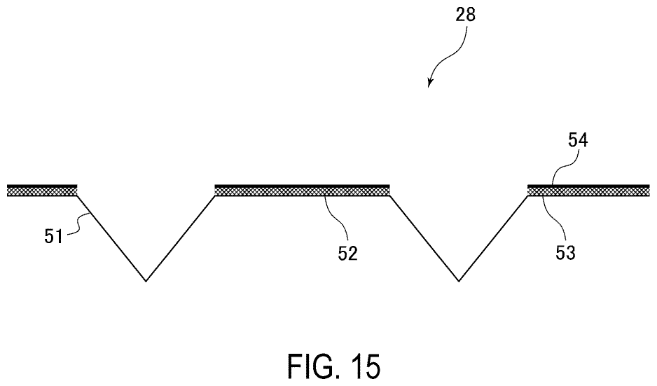

A second embodiment will be described using FIG. 15. In the constitution of the above-described first embodiment, the chromium layer 54 was provided on both the grooves 51 (groove portion) and the projected portion 52 (non-groove portion) of the surface of the developing sleeve 28. On the other hand, in a constitution of the second embodiment, the chromium layer 54 is provided on only the projected portion 52 (non-groove portion) of the surface of the developing sleeve 28. Other constitutions and actions in the second embodiment are similar to those in the above-described first embodiment, and therefore, similar constituent elements are omitted from description and illustration or briefly described by adding thereto the same reference numerals or symbols, and in the following, a difference from the first embodiment will be principally described.

In the constitution, the grooves 51 (groove portion) are not provided with the chromium layer 54, and therefore, there is no influence of the chromium layer 54 on the groove shape, so that conveyance of the developer by the grooves 51 (groove portion) is appropriately performed. Further, in the constitution of this embodiment, a portion subjected to the chromium plating is only the projected portion 52 (non-groove portion), so that a degree of unevenness of the projected portion 52 (non-groove portion) is smaller than that of the grooves 51 (groove portion), and therefore, a condition setting during the chromium plating becomes easy.

On the other hand, in the where the portion subjected to the chromium plating is only the projected portion 52 (non-groove portion), compared with the case where both the grooves 51 (groove portion) and the projected portion 52 (non-groove portion) are subjected to the chromium plating, an effect of reducing the sleeve deposition toner becomes somewhat small. However, a ratio of an area of the grooves 51 (groove portion) to an area of the projected portion 52 (non-groove portion) is about 10% to about 40% and thus the projected portion 52 (non-groove portion) occupies a majority of regions of the outermost surface layer (outer surface) of the outer peripheral surface of the developing sleeve 28, so that even when the portion subjected to the chromium plating is only the projected portion 52 (non-groove portion), the reduction of the sleeve deposition toner can be sufficiently achieved.

Further, the grooves 51 (groove portion) are remoter from the photosensitive drum 1a compared with the projected portion 52 (non-groove portion), and therefore, the grooves 51 (groove portion) are less influenced by a potential change by the sleeve deposition toner than in the projected portion 52 (non-groove portion). From the above-described reasons, also in the constitution of this embodiment, the effect of reducing the sleeve ghost can be ensured.

The surface of the developing sleeve 28 in the second embodiment is provided with the chromium layer 54 at the outer surface of the projected portion 52 (non-groove portion), but is not provided with the chromium layer 54 at the outer surface of the grooves 51 (groove portion), as shown in FIG. 15.

The developing sleeve 28 in the second embodiment is prepared by providing the metal underlayer 53 which is an adhesive layer on the outer surface of the bare tube 56 which is a base layer after the bare tube 56 made of aluminum is appropriately subjected to the preliminary treatment or masking. The metal underlayer 53 is a layer of metal, and as the metal, nickel is used. That is, the electroless nickel layer subjected to the electroless plating is formed on the outer surface of the bare tube 56. The plurality of grooves 51 are formed on the outer peripheral surface of the developing sleeve 28 as under the above-described condition by using the die to the bare tube 56 including this plating layer. A processing property of the die at this time was such that the processing was not easy when the layer thickness (chromium layer thickness) of the chromium plating is larger than 5 μm. For that reason, it can be said that from the viewpoint of the processing property, the thickness of the chromium layer provided at the outer surface of the projected portion 52 (non-groove portion) of the developing sleeve 28 may preferably be 5 μm or less.

On the other hand, from a viewpoint of suppressing the occurrence of the sleeve ghost, the thickness of the chromium layer provided at the other surface of the projected portion 52 (non-groove portion) of the developing sleeve 28 may preferably be made 1 μm or more. Therefore, in the second embodiment, the thickness of the chromium layer provided at the outer surface of the projected portion 52 (non-groove portion) of the developing sleeve 28 may preferably be 1 μm or more and 5 μm or less.

For the embodiment 2 using the developing sleeve 28 in the above-described second embodiment, a test image was output under a condition similar to that in the above-described comparison examples. A result of this is shown in the above-described table 4. In the embodiment 2, the thickness of the chromium layer 54 provided at the outer surface of the projected portion 52 (non-groove portion) of the developing sleeve 28 is made 4.2 μm. As is understood from the result of the table 4, in this embodiment, similarly as in the embodiment 1d, the occurrence of the sleeve ghost can be suppressed.

As described above, in the second embodiment, even in the constitution including, as the outermost surface layer of the outer peripheral surface of the developing sleeve 28, the chromium layer 54 only in the projected portion 52 (non-groove portion), the deposition of the toner onto the developing sleeve 28 can be suppressed, and the occurrence of the sleeve ghost can be suppressed. Further, in the second embodiment (embodiment 2), similarly as in the first embodiment (embodiment 1), the sleeve ghost can be suppressed by the simple and inexpensive constitution.

### Third Embodiment

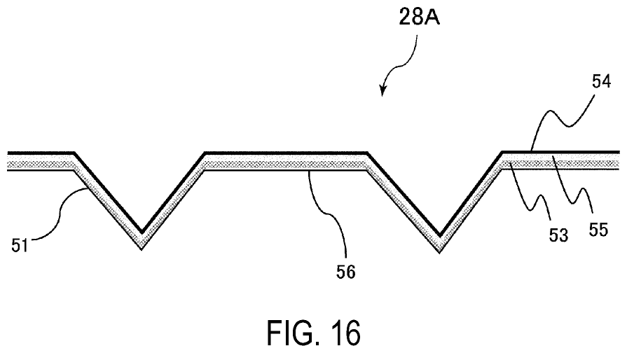

A third embodiment will be described using FIG. 16. In this embodiment, in the above-described constitution of the first embodiment, as a layer under the chromium layer 54, an electrolytic layer containing phosphorus in a small amount is provided. Other constitutions and actions in the second embodiment are similar to those in the above-described first embodiment, and therefore, similar constituent elements are omitted from description and illustration or briefly described by adding thereto the same reference numerals or symbols, and in the following, a difference from the first embodiment will be principally described.

A factor of the sleeve ghost is an image hysteresis of the amount of the sleeve deposition toner, and in the first embodiment, entirety of the amount of the sleeve deposition toner was decreased by using the chromium layer 54. On the other hand, in this embodiment, a minute magnetic property is imparted to the developing sleeve 28, whereby an image hysteresis eliminating effect of the amount of the sleeve deposition toner is increased.

A surface of a developing sleeve 28A includes, as shown in FIG. 16, the chromium layer 54 as the outermost surface layer of the outer peripheral surface thereof and a metal intermediate layer 55 which is a phosphorus containing metal layer between the bare tube 56 made of aluminum which is a base layer, and the chromium layer 54. That is, the developing sleeve 28A in this embodiment is prepared by forming a plurality of grooves 51 with a die on an outer peripheral surface of a bare tube 56 made of aluminum. Then, the outer peripheral surface of the bare tube 56 which is a base layer is appropriately subjected to preliminary treatment and masking, and then a metal underlayer 53 which is an adhesive layer is formed on the outer peripheral surface of the bare tube 56. The metal underlayer 53 is a layer plating of metal, and as the metal, nickel or copper is used. That is, on the outer peripheral surface of the bare tube 56, an electroless nickel plating layer is formed or a copper plating layer is formed by electroplating.

Then, the metal intermediate layer 55 is formed on an outer peripheral surface of the metal underlayer 53. The metal intermediate layer 55 is provided by forming a nickel electroplating layer containing phosphorus in an amount of 1% or more (1 weight % or more) and 4% or less (4 weight % or less) on the outer peripheral surface of the metal underlayer 53 through electroplating. Thereafter, the chromium layer (metal surface layer 54 is formed on the outer peripheral surface of the metal intermediate layer 55. The chromium layer 54 is provided by forming a chromium plating layer on the outer peripheral surface of the metal underlayer 53 by electroplating. In this embodiment, a thickness of the chromium plating layer is 4.2 μm. Incidentally, in the first embodiment, the processing method of the chromium layer 54 did not matter, but in this embodiment, there is a need to provide the nickel electroplating layer to the metal intermediate layer 55, so that the processing method may desirably be the plating.

In the comparison example 3 and the embodiment 1d described in the first embodiment described above and in the embodiment 3, in which the developing sleeve 28A of this embodiment described above was used, test images were output under the same condition as that in the above-described comparison examples. A result is shown in a table 5 below. In the embodiment 3, the thickness of the chromium layer 54 is 4.2 μm, the metal underlayer 53 is the electroless nickel plating layer, and the metal intermediate layer 55 is the electroless nickel plating layer. In the comparison example 3 and the embodiment 1d, the metal intermediate layer 55 is not provided. In the comparison example 3 and the embodiment 3, as described above, the carrier including 20 parts or more of silica fine particles as inorganic fine particles of 50 nm or more and 200 nm or less in terms of a number-average particle diameter in the coating resin layer is used.

TABLE 5

| | COMP. EX. 3 | EMB. 1d | EMB. 3 |
|---|---|---|---|
| TONER*¹ | CP + NCP | CP + NCP | CP + NCP |
| CC*² | SiPA | SiPA | SiPA |
| DSSL*³ | — | Cr(4.4 μm) | Cr(4.2 μm) |
| DSIL*⁴ | — | — | NEP |
| DSUL*⁵ | — | ENP | ENP |
| SG*⁶ | X | ◯ | ⊚ |

*¹“CP” is crystalline polyester. “CP + NCP” is (contrast potential polyester) + (non-contrast potential polyester).
*²“CC” is carrier coat(ing). “SiPA” is Si particle addition.
*³“DSSL” is a developing sleeve surface layer. “Cr” is Cr plating.
*⁴“DSIL” is a developing sleeve intermediate layer. “NEP” is Ni electroplating.
*⁵“DSUL” is a developing sleeve under layer. “ENP” is the electroless nickel plating.
*⁶“SG” is the sleeve ghost.

As shown in the table 5, in the case where the carrier containing 20 parts or more of the silica fine particles as the inorganic fine particles in the coating resin layer, although the sleeve ghost is liable to appear in the comparison example 3, it is understood that the occurrence of the sleeve ghost can be suppressed in the embodiment 1d. Further, in the embodiment 3, it is understood that the occurrence of the sleeve ghost can be further suppressed than in the embodiment 1d.

Accordingly, as in this embodiment, the outermost layer of the outer peripheral surface of the developing sleeve 28 is the chromium layer 54, and the metal intermediate layer 55 which is the metal layer containing the phosphorus is provided as the layer under the chromium layer 54, so that the occurrence of the sleeve ghost can be sufficiently suppressed even when the carrier containing 20 parts or more of the silica fine particles as the inorganic fine particles in the coating resin layer. In this embodiment, compared with the first embodiment, although a surface constitution becomes complicated, the development sleeve ghost can be suppressed more effectively. Therefore, also in the case of this embodiment, the deposition of the toner onto the developing sleeve 28A can be suppressed at a low cost. Particularly, according to this embodiment, even in the case where low-melting point toner using the crystalline polyester as the binder resin of the toner, and in addition, even when the carrier including 20 parts or more of the silica fine particles as the inorganic fine particles in the coating resin layer is used it becomes possible to suppress the sleeve ghost with the simple and in expensive constitution.

### OTHER EMBODIMENTS

The image forming apparatus 100 is not limited to the full-color printer, but may also be a monochromatic or monocolor printer. Further, the image forming apparatus 100 may also be printers, various printing machines, copying machines, facsimile machines, and multi-function machines having a plurality of functions of these machines.

Further, in the above-described embodiments, as the image bearing member, the photosensitive drums 1a to 1d which are a drum-shaped organic photosensitive member were used, but it is also possible to use an inorganic photosensitive member such as an amorphous photosensitive member. In addition, it is also possible to use a belt-shaped photosensitive member. Also, as regards the charging type, the transfer type, the cleaning type, and the fixing type, there types are not limited thereto.

Further, in the above-described first, second and third embodiments, the case where the present disclosure was applied to the developing device 4a in which the developing chamber 23 and the stirring chamber 24 were vertically disposed was described, but the developing device is not limited thereto. For example, the present disclosure is also applicable to a developing device, in which a developing chamber and a stirring chamber are horizontally disposed, s used conventionally, or a developing devices in other forms.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications Nos. 2025-062174, filed on Apr. 4, 2025, and 2026-036133, filed on Mar. 6, 2026, which are hereby incorporated by reference herein in their entirety.

What is claimed is:

1. A rotatable sleeve comprising:
a developer carrying and conveying portion configured to carry and convey a developer containing toner and a carrier to a developing position, the developer carrying and conveying portion including a groove portion which is a portion where a groove is formed and a non-groove portion where the groove is not formed,
wherein in a case where a depth of the groove is D, a radius of the carrier is R, and a width of the groove in a rotational direction of the sleeve is W, D>R and W>2R are satisfied, and
wherein the non-groove portion includes a chromium layer on an outer surface of the sleeve, and the chromium layer is 1 μm or more and 5 μm or less in thickness.

2. The sleeve according to claim 1, wherein the non-groove portion includes a metal underlayer, which is a metal layer, between a base layer and the chromium layer of the sleeve.

3. The sleeve according to claim 2, wherein the metal underlayer is a nickel-plated layer.

4. The sleeve according to claim 2, wherein the metal underlayer is a copper-plated layer.

5. The sleeve according to claim 1, wherein the non-groove portion includes a metal intermediate layer, which is a metal layer containing phosphorus, between a base layer and the chromium layer of the sleeve and includes a metal underlayer, which is a metal layer, between a base layer and the metal intermediate layer.

6. The sleeve according to claim 5, wherein the metal intermediate layer is a nickel-plated layer containing phosphorus, and the metal underlayer is the nickel-plated layer.

7. A rotatable sleeve comprising:
a developer carrying and conveying portion configured to carry and convey a developer containing toner and a carrier to a developing position, the developer carrying and conveying portion including a groove portion which is a portion where a groove is formed and a non-groove portion where the groove is not formed,
wherein in a case where a depth of the groove is D, a radius of the carrier is R, and a width of the groove in a rotational direction of the sleeve is W, D>R and W>2R are satisfied, and
wherein each of the groove portion and the non-groove portion includes a chromium layer on an outer surface of the sleeve.

8. The sleeve according to claim 7, wherein the chromium layer is 1 μm or more and 5 μm or less in thickness.

9. The sleeve according to claim 7, wherein each of the groove portion and the non-groove portion includes a metal underlayer, which is a metal layer, between a base layer and the chromium layer of the sleeve.

10. The sleeve according to claim 9, wherein the metal underlayer is a nickel-plate of layer.

11. The sleeve according to claim 9, wherein the metal underlayer is a copper-plated layer.

12. The sleeve according to claim 7, wherein each of the groove portion and the non-groove portion includes a metal intermediate layer, which is a metal layer containing phosphorus, between a base layer and the chromium layer of the sleeve and includes a metal underlayer, which is a metal layer, between a base layer and the metal intermediate layer.

13. The sleeve according to claim 12, wherein the metal intermediate layer is a nickel-plated layer containing phosphorus, and the metal underlayer is the nickel-plated layer.

14. A developer carrying member comprising:
a rotatable sleeve; and
a magnet provided inside the sleeve,
wherein the sleeve includes a developer carrying and conveying portion which is configured to carry and convey a developer containing toner and a carrier to a developing position and which includes a groove portion which is a portion where a groove is formed and a non-groove portion where the groove is not formed,
wherein in a case where a depth of the groove is D, a radius of the carrier is R, and a width of the groove in a rotational direction of the sleeve is W, D>R and W>2R are satisfied, and
wherein the non-groove portion includes a chromium layer on an outer surface of the sleeve, and the chromium layer is 1 μm or more and 5 μm or less in thickness.

15. A developer carrying member comprising:
a rotatable sleeve; and
a magnet provided inside the sleeve,
wherein the sleeve includes a developer carrying and conveying portion which is configured to carry and convey a developer containing toner and a carrier to a developing position and which includes a groove portion which is a portion where a groove is formed and a non-groove portion where the groove is not formed,
wherein in a case where a depth of the groove is D, a radius of the carrier is R, and a width of the groove in a rotational direction of the sleeve is W, D>R and W>2R are satisfied, and
wherein each of the groove portion and the non-groove portion includes a chromium layer on an outer surface of the sleeve.

16. The developer carrying member according to claim 15, wherein the chromium layer is 1 μm or more and 5 μm or less in thickness.

17. A developing device comprising:
a developing container configured to accommodate a developer containing toner and a carrier; and
a developer carrying member including a rotatable sleeve and a magnet provided inside the sleeve,
wherein the sleeve includes a developer carrying and conveying portion which is configured to carry and convey the developer to a developing position and which includes a groove portion which is a portion where a groove is formed and a non-groove portion where the groove is not formed,
wherein in a case where a depth of the groove is D, a radius of the carrier is R, and a width of the groove in a rotational direction of the sleeve is W, D>R and W>2R are satisfied, and
wherein the non-groove portion includes a chromium layer on an outer surface of the sleeve, and the chromium layer is 1 μm or more and 5 μm or less in thickness.

18. A developing device comprising:
a developing container configured to accommodate a developer containing toner and a carrier; and
a developer carrying member including a rotatable sleeve and a magnet provided inside the sleeve,
wherein the sleeve includes a developer carrying and conveying portion which is configured to carry and convey the developer to a developing position and which includes a groove portion which is a portion where a groove is formed and a non-groove portion where the groove is not formed,
wherein in a case where a depth of the groove is D, a radius of the carrier is R, and a width of the groove in a rotational direction of the sleeve is W, D>R and W>2R are satisfied, and
wherein each of the groove portion and the non-groove portion includes a chromium layer on an outer surface of the sleeve.

19. The developing device according to claim 18, wherein the chromium layer is 1 μm or more and 5 μm or less in thickness.
